(19) United States
(12) Patent Application Publication
(10) Pub. No.: US 2018/0336454 A1
(43) Pub. Date: Nov. 22, 2018

(54) NEURAL NETWORK SYSTEMS

(71) Applicant: General Electric Company, Schenectady, NY (US)

(72) Inventors: Ser Nam Lim, Niskayuna, NY (US); Xiao Bian, Niskayuna, NY (US); Wei-Chih Hung, Merced, CA (US); David Scott Diwinsky, West Chester, OH (US)

(21) Appl. No.: 15/600,294

(22) Filed: May 19, 2017

(51) Int. Cl. G06N 3/04; G06T 1/20; G06K 9/46; G06K 9/00

(52) U.S. Cl. CPC G06N 3/0472; G06K 9/00979; G06K 9/4619; G06T 1/20

(57) ABSTRACT

The systems and methods herein relate to artificial neural networks. The systems and methods examine an input image having a plurality of instances using an artificial neural network, and generate an affinity graph based on the input image. The affinity graph is configured to indicate positions of the instances within the input image. The systems and methods further identify a number of instances of the input image by clustering the instances based on the affinity graph.

### FIELD

The subject matter described herein relates to artificial neural networks.

### BACKGROUND

Artificial neural networks can be used to analyze images for a variety of purposes. For example, some artificial neural networks can examine images in order to identify instances depicted in images. The images may have one or more instances, such as a human, bicycle, boat, plane, tree, house, car, and/or the like. Instances can extend across multiple pixels within the image, surround other instances, positioned behind and/or in front of other instances, and/or the like. The artificial neural networks can be trained to detect various instances in images by providing the artificial neural networks with labeled training images. The labeled training images include images having a known instance depicted in the images, with each pixel in the labeled training images identified according to what instances the pixel at least partially represents.

However, conventional artificial neural networks have issues identifying multiple instances within an input image. The conventional neural networks assign an instance label to each pixel by dividing the image based on a region task and a mask prediction task. The region task subdivides the image into regions that correspond to instances within the image. The regions are formed based on features of the pixels that correspond to one of the instances. The region task can bottleneck the identifying of the instances based on a number of instances. The mask prediction task can utilize clustering within the region to segment the instances from the image.

### BRIEF DESCRIPTION

In an embodiment a method (e.g., of instance semantic segmentation at the artificial neural network) is provided. The method includes examining an input image having a plurality of instances using an artificial neural network, and generating an affinity graph based on the input image. The affinity graph is configured to indicate positions of the instances within the input image. The method includes identifying a number of instances of the input image by clustering the instances based on the affinity graph.

In an embodiment a system (e.g., an artificial neural network system) is provided. The system includes a memory configured to store an artificial neural network and a controller circuit. The controller circuit is configured to examine an input image having a plurality of instances at the artificial neural network, and generate an affinity graph based on the input image. The affinity graph is configured to indicate positions of the instances within the input image. The controller circuit is configured to identify a number of instances of the input image by clustering the instances based on the affinity graph.

In an embodiment a method (e.g., of instance semantic segmentation at the artificial neural network) is provided. The method includes examining an input image having a plurality of instances using an artificial neural network, determine a feature map of the input image. The feature map includes feature vectors based on characteristics of pixels within the input image. The method includes selecting feature pairs of the feature map to identify feature pairs that have a common instance, and identifying classes of pixels in the input image. The classes categorize the instances of the input image. The method includes determining a probability map. The probability map indicating a probability a feature pair of a feature map are a part of a common instance. The method includes generating an affinity graph based on the input image and the feature map. The affinity graph is configured to indicate positions of the instances within the input image. The method includes identifying a number of instances of the input image by clustering the instances based on the affinity graph. The classes are utilized during the clustering of the instances.

### BRIEF DESCRIPTION OF THE DRAWINGS

The present inventive subject matter will be better understood from reading the following description of non-limiting embodiments, with reference to the attached drawings, wherein below:

FIG. 1 illustrates a flow chart of a conventional artificial neural network for identifying instances within an image;

FIG. 2 illustrates a schematic block diagram of an embodiment for an artificial neural network system;

FIG. 3 illustrates a network architecture of an embodiment to train an artificial neural network;

FIG. 4 illustrates a flowchart of an embodiment for a method of instance semantic segmentation at the artificial neural network;

FIG. 5 illustrates a network architecture of an embodiment of an artificial neural network;

FIG. 6A illustrates an embodiment of an input image;

FIG. 6B illustrates an embodiment of an affinity graph; and

FIG. 7 illustrates an embodiment of an input image and an output image with identified instances based on an artificial neural network 500.

### DETAILED DESCRIPTION

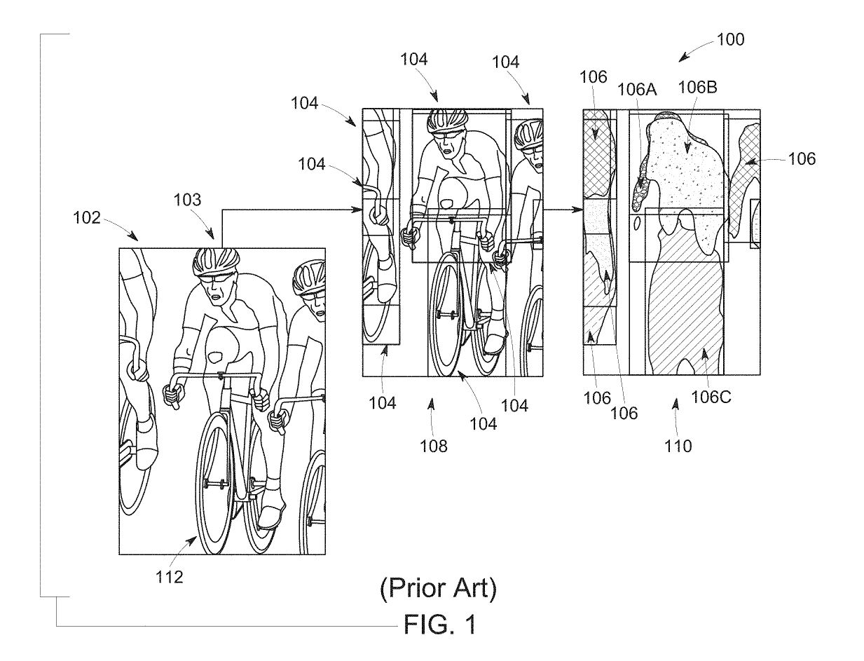

Conventional artificial neural networks are configured for image classification and instance detection at a pixel-level. An instance represents an object within an image. Instances can extend across multiple pixels within the image. For example, an instance may be surrounded by other instances, positioned behind and/or in front of an alternative instance, and/or the like. Images can have multiple instances corresponding to an object, such as a human, bicycle, boat, plane, tree, house, car, and/or the like. Conventional artificial neural networks identify the instances based on characteristics (e.g., such as the intensities, colors, gradients, histograms, and/or the like) of the pixels within the image. Based on the characteristics, the conventional artificial neural network determines a type of instance (e.g., tear, car, tree, ground, person, face, and/or the like) represented by the pixel. However, in connection with FIG. 1, conventional artificial neural networks have issues and/or identifying images having multiple instances.

FIG. 1 illustrates a flow chart 100 of a conventional artificial neural network for identifying instances within an image 102. The image 102 illustrates a person 103 riding a bicycle 112 representing two different instances. Conventional artificial neural networks assign an instance label to each pixel by dividing the image based on a region task (e.g., illustrated in an image 108) and a mask prediction task (e.g., illustrated in an image 110). The image 108 includes different regions 104 defined by the conventional neural network. The regions 104 subdivide the image 108 into different regions 104 that correspond to identified instances within the image 108 by the conventional artificial network. The regions 104 are formed based on the features of the pixels that correspond to different instances by the conventional artificial network. Based on the regions 104, the conventional artificial neural network performs a mask prediction task, as illustrated at the image 110. The mask prediction task utilizes clustering within the regions 104 of the identified instances to segment the instances 106 from the image 110. For example, the mask prediction task determined by the conventional artificial neural network has identified three different instances 106a-c for the person 103 riding the bicycle 112. However, the conventional artificial neural network miss-identified the instances 106a-c of the image 102 (e.g., the person 103, the bicycle 112). The instance 106c includes a portion of the person 103 (e.g., the legs). Additionally, the conventional artificial neural network divided the person 103 into separate instances 106a and 106b.

The systems and methods described herein relate to identifying multiple instances utilizing an artificial neural network. Rather than using the region task as described above, the system and methods automatically identifies a number of instances within an image by generating an affinity graph. The affinity graph is configured to indicate positions within the image of pixels having common instances. The affinity graph includes varying pixel intensities based on the image. Matching pixel intensities indicate that pixels represent a common instance. The affinity graph is formed by the artificial neural network based on a feature map. The feature map is formed by a plurality of feature vectors representing pixels of the image. The feature vector [a b c . . . N] may be associated with characteristics of the pixels of the image. For example, the feature vector may represent an array including intensity information, histogram, color, contrast, and/or the like of a pixel of the input image. The artificial neural network selects feature pairs of pixels in the feature map. The feature vectors of the feature pairs are compared by the artificial neural network to determine if the feature pairs are a part of the same instance. The determination of the common instances based on the feature pairs form the affinity graph. The artificial neural network may determine a probability map based on the feature pairs. The probability map is configured to indicate a probability the feature pairs are a part of the same instance.

Based on the affinity graph, the artificial neural network is configured to cluster the common instances for segmentation. For example, the artificial neural network may perform a mean shift clustering for each common instance. The artificial neural network may select feature pairs having common instances as indicated by the affinity graph. The artificial neural network may iteratively repeat the clustering for classes of the instances in the image. Based on the clustering, a number of instances are determined in the image.

Additionally or alternatively, the artificial neural network may determine a center of the clusters. The center of the cluster may represent a center of the instances in the image. The center of the clusters may be determined based on the probability map. For example, the center of the clusters correspond to a higher probability that the pixels belong in the same instance. As the pixels are further removed from the center of the cluster, the probability the pixel belongs in the same instance decreases.

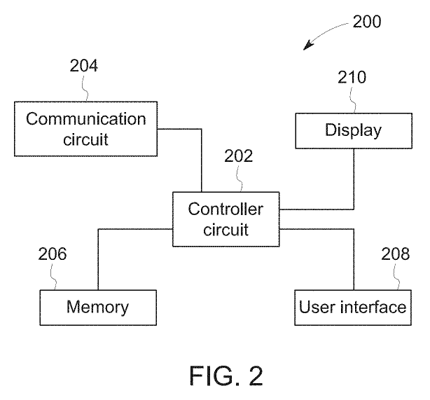

FIG. 2 illustrates a schematic block diagram of an embodiment for an artificial neural network system (ANNS) 200. The ANNS 200 may include a controller circuit 202 operably coupled to a communication circuit 204. Optionally, the ANNS 200 may include a display 210, a user interface 208, and/or a memory 206.

The controller circuit 202 is configured to control the operation of the ANNS 200. The controller circuit 202 may include one or more processors. Optionally, the controller circuit 202 may include a central processing unit (CPU), one or more microprocessors, a graphics processing unit (GPU), or any other electronic component capable of processing inputted data according to specific logical instructions. Optionally, the controller circuit 202 may include and/or represent one or more hardware circuits or circuitry that include, are connected with, or that both include and are connected with one or more processors, controllers, and/or other hardware logic-based devices. Additionally or alternatively, the controller circuit 202 may execute instructions stored on a tangible and non-transitory computer readable medium (e.g., the memory 206).

The controller circuit 202 may be operably coupled to and/or control the communication circuit 204. The communication circuit 204 is configured to receive and/or transmit information with one or more alternative ANNS, a remote server, and/or the like along a bi-directional communication link. For example, the communication circuit 204 may receive the artificial neural network via the bi-directional communication link. The communication circuit 204 may represent hardware that is used to transmit and/or receive data along a bi-directional communication link. The communication circuit 204 may include a transceiver, receiver, transceiver and/or the like and associated circuitry (e.g., antennas) for wired and/or wirelessly communicating (e.g., transmitting and/or receiving) with the one or more alternative compression systems, the remote server, and/or the like. For example, protocol firmware for transmitting and/or receiving data along the bi-directional communication link may be stored in the memory 206, which is accessed by the controller circuit 202. The protocol firmware provides the network protocol syntax for the controller circuit 202 to assemble data packets, establish and/or partition data received along the bi-directional communication links, and/or the like.

The bi-directional communication link may be a wired (e.g., via a physical conductor) and/or wireless communication (e.g., utilizing radio frequency (RF)) link for exchanging data (e.g., data packets) between the one or more alternative medical imaging systems, the remote server, and/or the like. The bi-directional communication link may be based on a standard communication protocol, such as Ethernet, TCP/IP, WiFi, 802.11, a customized communication protocol, Bluetooth, and/or the like.

The controller circuit 202 is operably coupled to the display 210 and the user interface 208. The display 210 may include one or more liquid crystal displays (e.g., light emitting diode (LED) backlight), organic light emitting diode (OLED) displays, plasma displays, CRT displays, and/or the like. The display 210 may display input images and/or output images stored in the memory 206, and/or the like received by the display 210 from the controller circuit 202.

The user interface 208 is configured to control operations of the controller circuit 202 and the ANNS 200. The user interface 208 is configured to receive inputs from the user and/or operator of the ANNS 200. The user interface 208 may include a keyboard, a mouse, a touchpad, one or more physical buttons, and/or the like. Optionally, the display 210 may be a touch screen display, which includes at least a portion of the user interface 208.

The memory 206 includes parameters, algorithms, data values, and/or the like utilized by the controller circuit 202 to perform one or more operations described herein. The memory 206 may be a tangible and non-transitory computer readable medium such as flash memory, RAM, ROM, EEPROM, and/or the like. The memory 206 may be configured to store the artificial neural network, define the artificial neural network, and/or the like.

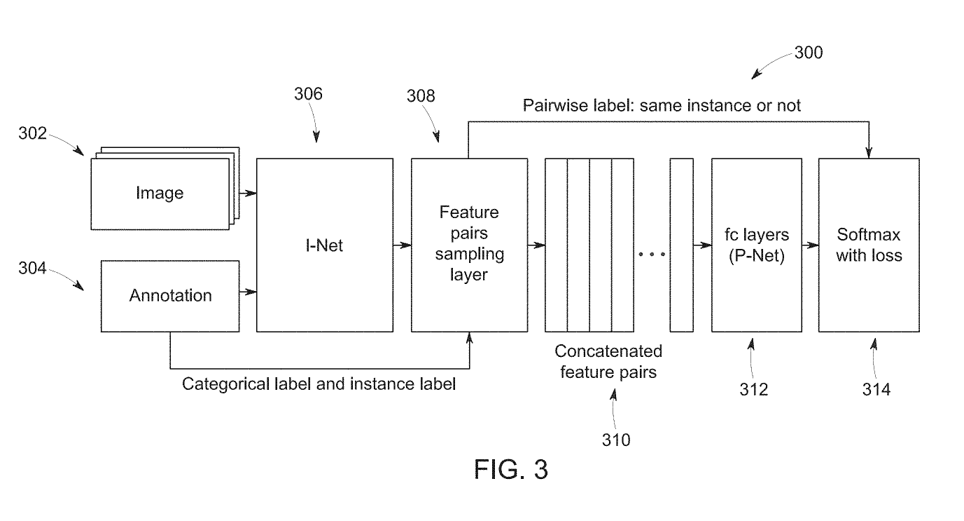

In connection with FIG. 3, the controller circuit 202 may define the artificial neural network. For example, the controller circuit 202 may be configured to train the artificial neural network based on a set of training images 302. The components 306, 308, 310, 312, 314 of the artificial neural network may correspond to artificial neuron layers or nodes that receive information of the set of training images 302 and perform operations (e.g., functions) on the information, selectively passing the results on to other neurons and/or components 306, 308, 310, 312, 314. For example, the controller circuit 202 may define the components 306, 308, 310, 312, 314 of the artificial neural network based on the set of training images 302. The training of the artificial neural network is utilized to form the affinity graph. For example, the training enables the artificial neural network to determine that pixels of a feature pair are a part of the same instance.

FIG. 3 illustrates a network architecture 300 of an embodiment to train the artificial neural network. The controller circuit 202 may be configured to receive the set of training images 302. The set of training images 302 include one or more images having a plurality of instances. Optionally, the set of training images 302 may be stored in the memory 206. For example, the set of training images 302 may be selected by the user based on selections received by the controller circuit 202 from the user interface 208. Additionally or alternatively, the set of training images 302 may be received along a bi-directional communication link from the remote server.

The set of training images 302 may be grouped into categories. For example, the instances within the set of training images 302 may include annotations 304. The annotation 304 may categorize and/or identify the pixels in the set of training images 302 to a type and/or class of instances of the set of training images 302.

The network architecture 300 includes an I-Net layer 306. The I-Net layer 306 may be defined and/or configured by the controller circuit 202 based on the set of training images 302 and the annotations 304. The I-Net layer 306 includes a set of artificial neural layers, which are defined and/or formed by the controller circuit 202. The artificial neural layers can represent artificial neurons and/or nodes, which receive an input image from the set of training images 302 and performs operations (e.g., functions) on the input image, selectively passing the results on to other neurons and/or other components 306, 308, 310, 312, 314.

The artificial neuron layers of the I-Net layer 306 can examine individual pixels of the input image to define a feature vector. The feature vector [a b c . . . n] may be associated with characteristics of the pixels of the image. For example, the feature vector may represent an array including intensity information, histogram, color, contrast, and/or the like of a pixel of the input image. The operations performed by the artificial neuron layers of the I-Net layer 306 are configured to determine a feature map of the input image. The feature map includes an array of the feature vectors representing the pixels of the input image received by the I-Net layer 306.

In an embodiment, a size of the feature map is configured to be the same size as the input image. For example, one of the artificial neural layers may be configured to perform a deconvolution on the feature map for a one-to-one mapping between the pixels and the feature vectors. The one-to-one mapping further configures the feature map to be the same size as the input image.

The output of the I-Net layer 306 (e.g., the feature map) is received by the FPS layer 308. The FPS layer 308 is configured to generate a feature pair array of feature pairs. The feature pairs represent pairs of pixels of the feature map. For example, the controller circuit 202 executing the FPS layer 308 may select a first and second pixel of the feature map. The first and second pixel in the feature map may correspond to a 128 dimension feature vector. The FPS layer 308 may combine the feature vectors of the first and second pixel to form a 256 dimension feature pair, which forms a part of the feature pair array. Based on the annotation 304, the controller circuit 202 may define and/or train the FPS layer 308 to identify pairs that have a common instance.

For example, the controller circuit 202 may be configured to iteratively select random pixel pairs from the input image, such as 10,000 pixel pairs. Optionally, to avoid data imbalance, 10,000 pixel pairs may be selected using the annotation 304 such that an equal number of pixel pairs belong in the same instance and the remaining pixel pairs belong to different instances. Based on the feature pairs that belong to the same instances, the controller circuit 202 may define a mathematical function of the artificial neural layers of the FPS layer 308. The mathematical function is configured, by the controller circuit 202, to identify the similarities of the feature vectors of the feature pairs to identify feature pairs that are in the same instance.

The concatenated feature pair layer 310 may represent artificial neuron layers configured to combine the feature pair arrays that are identified by the FPS layer 308 corresponding to the same instance. For example, the concatenated feature pair layer 310 is configured to identify the feature pairs that belong to the same instance.

The network architecture 300 includes a P-Net layer 312. The FPS layer 308 may be interposed between the I-Net layer 306 and the P-Net Layer 312. The P-Net layer 312 is configured to generate an affinity graph. The affinity graph is configured to indicate positions within the image of pixels having common instances. The affinity graph includes varying pixel intensities based on the image. Matching pixel intensities indicate that pixels represent a common instance. For example, the identified pixels pairs that belong to the same instance combined at the concatenated feature pair layer 310, are configured to match in the affinity graph. For example, the identified pixels pairs may have the same intensity and/or color in the affinity graph. The softmax component 314 is configured to normalize the affinity graph generated by the P-Net layer 312. For example, the softmax component 314 is configured to provide a non-linear variant for multinomial logistic regression.

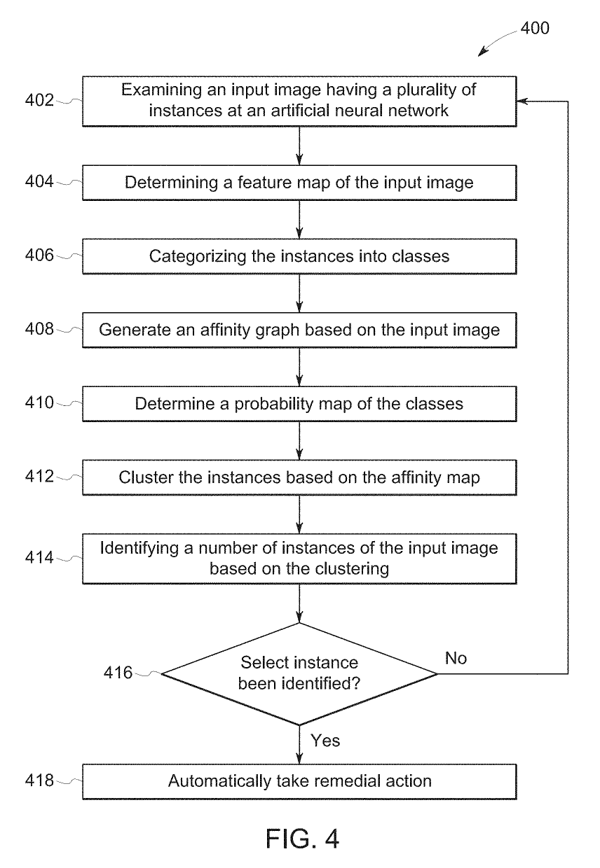

In connection with FIG. 4, the controller circuit 202 may utilize the trained artificial neural network to identify instances within an input image.

FIG. 4 illustrates a flowchart of an embodiment for a method 400 of instance semantic segmentation at the artificial neural network. The method 400, for example, may employ structures or aspects of various embodiments (e.g., systems and/or methods) discussed herein. In various embodiments, certain steps (or operations) may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 400 may be used as one or more algorithms to direct hardware to perform one or more operations described herein.

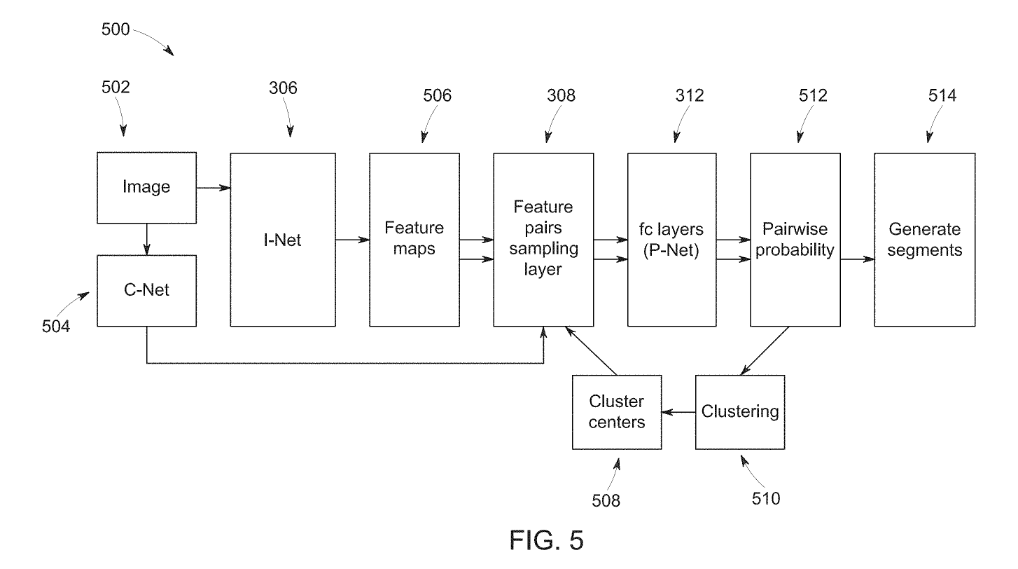

Beginning at 402, the controller circuit 202 may be configured to examine an input image 502 having a plurality of instances at an artificial neural network 500. FIG. 5 illustrates a network architecture of an embodiment of the artificial neural network 500. The artificial neural network 500 may be stored in the memory 206, and executed by the controller circuit 202. The artificial network 500 may include the I-Net layer 306, the FPS layer 308, and the P-Net 312, which may be trained and/or defined by the controller circuit 202 and/or received along the bi-directional communication link from the remote server.

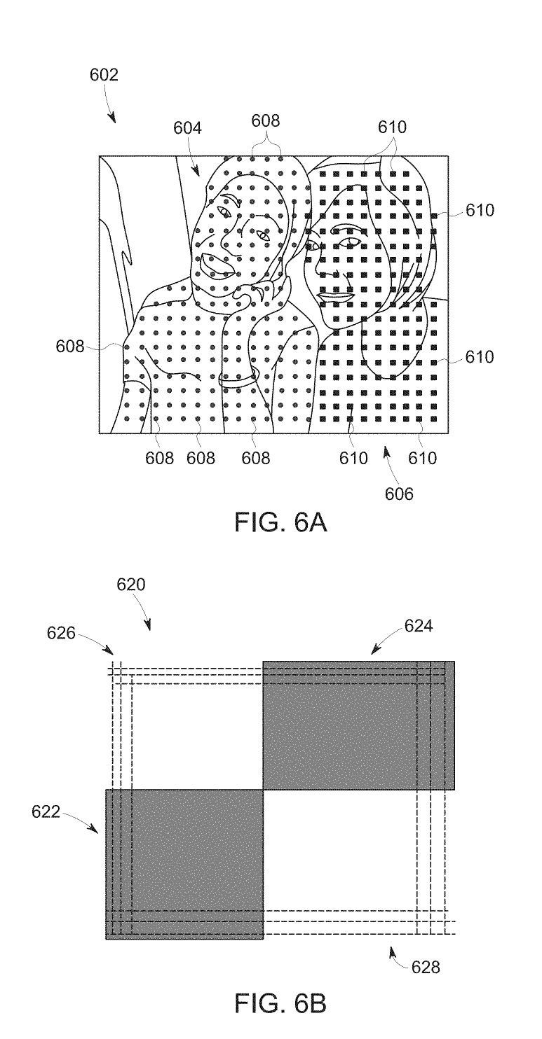

FIG. 6A illustrates an embodiment of an input image 602 (e.g., the input image 502). The input image 602 includes a plurality of instances, such as the instances 604 and 606, representing different people within the input image 602.

Returning to FIG. 4, at 404, the controller circuit 202 may be configured to determine a feature map 506 of the input image 502. For example, the I-Net layer 306 (FIG. 5) may receive the input image 502. The I-Net layer 306 may examine individual pixels of the input image 502 to define feature vectors. The feature vectors are associated with characteristics of the pixels of the input image 502. For example, the feature vector may represent an array including intensity information, histogram, color, contrast, and/or the like of a pixel of the input image 502. The I-Net layer 306 may determine feature vectors for the pixels of the input image 502. The feature vectors can be arranged into the feature map 506 by the I-Net layer 306.

At 406, the controller circuit 202 may categorize the pixels of the input image 502 into classes. The artificial neural network 500 includes a C-Net layer 504. The C-Net layer 504 includes a set of artificial neural layers. The C-Net layer 504 includes artificial neurons, or nodes, that receive the input images 502 and perform operations (e.g., functions) on the images, selectively passing the results on to other neurons. The C-Net layer 504 is configured to determine vectors for each of the pixels of the input image 502. The vectors include weight values that are associated with different classes of instances. The classes of instances may be similar to and/or the same as the annotation 304 (FIG. 3) that provide a category and/or label of the instance represented by the pixel. For example, the class may be a human, a face, a tear, a crack, a car, a tree, ground, and/or the like. The weight values constrain how input images 502 are related to outputs of the neurons. For example, the C-Net layer 504 based on the artificial neural layers is configured to automatically identify one or more classes of instances in the input image 502 examined by the artificial neural layers of the C-Net layer 504. Weight values can be determined by the iterative flow of training images through the C-Net layer 504. For example, weight values are established during a training phase by the controller circuit 202 and/or remotely by the remote server in which the C-Net layer 504 learns how to identify particular classes of the pixels by typical input data characteristics of the instances in the training images.

The C-Net layer 504 may include an input layer that receives the input image 502 and an output layer that outputs an output image that includes the classification of the pixels. It may be noted that the C-Net layer 504 can include one or more intermediate layers. The artificial neural layers of the C-Net layer 504 represent different groups or sets of artificial neurons, which can represent different functions performed by the controller circuit 202 on the input image 502 to classify pixels within the input image 502. The artificial neurons apply different weights in the functions applied to the input image 502 to attempt to identify the classes of pixels in the input image 502. The output image is generated by the C-Net layer 504 by assigning or associating different pixels in the output image with different object classes (described below) based on analysis of characteristics of the pixels. The output image of the C-Net layer 504 can be received by the FPS layer 308. Because the C-Net layer 504 may not be 100% accurate in predicting what objects are represented by different pixels, the output image may not exactly resemble or depict the classifications of instances in the input image 502.

The artificial neuron layers of the C-Net layer 504 can examine individual pixels in the input image 502. The controller circuit 202 executing and/or examining the artificial neuron layers can use linear classification to calculate scores for different classes of instances. For example, the C-Net layer 504 may be configured to calculate scores for over 1000 different categories of objects. These scores can indicate the probability that the pixel represents different classes. For example, the score for the pixel can be represented as one or more of the vectors. The one or more vectors [a b c d] may be associated with probabilities that the pixel represents various different object classes, where the values of a, b, c, and d indicate the probability of the pixel representing each of a different classes of instances or objects.

Each artificial neuron layer can apply a mathematical function, such as an activation function, to the same pixel, with the functions applied by different neurons impacting the functions applied by other neurons and different neurons applying different weights to different terms in the functions than one or more, or all other neurons. Application of the functions generates the classification scores for the pixels, which can be used to classify pixels in the input image 502.

The neurons in the artificial neuron layers of the C-Net layer 504 are configured to examine the characteristics of the pixels, such as the intensities, colors, gradients, histograms, and/or the like, to determine the scores for the various pixels of the input image 502. The C-Net layer 504 examines the score vector of each pixel after the artificial neuron layers of the C-Net layer 504 have determined the score vectors for the pixels and determines which class has the highest probability for each pixel or which instance class has a higher probability than one or more, or all, other object classes for each pixel.

At 408, the controller circuit 202 may generate an affinity graph 620 (FIG. 6B) based on the input image 602. In connection with FIG. 5, the FPS layer 308 receives the feature map 506. The FPS layer 308 is configured to generate a feature pair array based on the feature pairs of pixels of the feature map 506. The FPS layer 308 may be configured to sample the input image 502 with a fixed stride. The FPS layer 308 may analyze the pixels of the input image 502 both horizontally and vertically to analyze the entire input image 502 evenly based on the feature map 506. For example, the FPS layer 308 may evaluate all possible feature vector pairs (e.g., selection of two feature vectors of two pixels) of the feature map 506 represented as n (n−1)/2. The variable n may represent a number of feature vectors of the feature map 506.

The FPS layer 308 may compare select feature pairs to identify pairs of pixels that have and/or belong in the same instance. For example, a value generated by the mathematical function executed by the controller circuit 202 of the FPS layer 308 may identify if the feature vector pairs belong in the same instance. The identified feature pairs are received by the P-Net layer 312. Additionally or alternatively, the FPS layer 308 may utilize the output image of the C-Net layer 504 to identify pairs of pixels that belong in the same instance. For example, the output image may indicate the classes of the feature pairs of the feature map 506. Based on the class of the feature pairs, the FPS layer 308 may determine that pixels that are identified as the same class belong in the same instance.

The P-Net layer 312 is configured to generate the affinity graph 620. FIG. 6B illustrates an embodiment of the affinity graph 620. The affinity graph 620 is configured to indicate positions within the input image 602 of pixels having common instances. The affinity graph includes varying pixel intensities shown in portions 622, 624, 626, and 628 based on the input image 602 and the feature map 506. Matching pixel intensities indicate that pixels represent a common instance.

At 410, the controller circuit 202 may be configured to determine probability maps of the classes based on the affinity map. For example, the probability maps may be an iterative process by determining a probability map for each of the classes identified by the C-Net layer 504. It may be noted that the C-Net layer 504 may be configured to not overlap pixels into multiple classes. For example, the C-Net layer 504 is configured to select a single class for the pixels. Based on the no overlap in the classes, each feature vector is involved in at most one of the iterative passes to determine the probability maps. In connection with FIG. 5, a pairwise probability layer 512 may be configured to determine probability maps of the feature pairs of pixels that formed the affinity graph 620. For example, the controller circuit 202 may determine probabilities of the feature pairs that belong to the same instance. The probabilities calculated by the controller circuit 202 may form the probability maps for the classes identified by the C-Net layer 504. The probabilities may be determined by the controller circuit 202 based on the classes identified by the C-Net layer 504. For example, the controller circuit 202 may calculate a higher probability for the feature pair that belong to the same instance when the classes of pixels identified by the C-Net layer 504 match, relative to a probability of zero when the classes of the feature pairs do not match. Optionally, the probabilities may be determined based on a position of the feature pairs with respect to each other. For example, when a position of the feature pairs are adjacent and/or within a set distance from each other may have a higher probability. It may be noted that the probability maps may have the same size as the input image 502.

At 412, the controller circuit 202 may be configured to cluster pixels that belong to common instances. The clustering layer 510 configured to use the affinity graph 620. The controller circuit 202 may iteratively perform the mean shift clustering on the affinity graph 620 based on a number of classes identified by the C-Net layer 504. For example, the controller circuit 202 may apply the mean shift clustering for each class on the pixels of the affinity graph 620. For a first class, the controller circuit 202 may identify pixels belonging to feature pairs of the feature pair array belonging to the first class (e.g., the pixels have the same intensity in the affinity graph 620). The clustering layer 510 may utilize probabilities of the feature pairs (e.g., determined at 410) of the classes for the mean shift clustering. For example, the controller circuit 202 may be configured to sum the probabilities to form a probability surface and/or density function for the affinity graph 620.

In connection with FIG. 6A, the input image 602 includes clustering points 608 and 610 identified by the clustering layer 510. The clustering points 608 and 610 may represent a portion of the feature pairs that belong to one of the classes identified by the C-Net layer 504. The clustering points 608 and 610 are shown divided between the two instances 604, 606. For example, the clustering points 608 are shown a part of the instance 604, and the clustering points 610 are shown a part of the instance 606.

A cluster center layer 508 may be configured to identify a center corresponding to a peak of the probability surface and/or density function of the clusters. For example, the peak may be identified based on a position of the probability surface and/or density function having a peak relative to the remaining probability surface. The center may be associated as an affinity center of the instances within the affinity graph 620.

Additionally or alternatively, more than one center corresponding to an instance may be identified by the clustering center layer 508 for a particular class. For example, the multiple centers may be based on the probabilities of the probability map of the particular class overlapping. Optionally, the cluster center layer 508 may be configured to select one of the centers based on a confidence value. For example, the cluster center layer 508 may calculate a confidence value (e.g., the variable Cf) based on the probability maps based on Equation 1. The variable pm represents the probability map of the particular class, and the variable (x, y) represents pixel locations of the particular class. The variable t represents a distribution of the probability map. For example, the variable t may be 0.1.

$$Cf = \frac{{\sum }_{x , y} 1 \{ min ( pm ( x , y ) , 1 - pm ( x , y ) ) < t \}}{{\sum }_{x , y} 1 \{ pm ( x , y ) \}} \qquad Equation ( 1 )$$

The confidence value represents how much each pixel is affirmed about being within the particular class. For example, the confidence value may takes into account the probability value of the feature pairs of the probability map. Probabilities of the feature pairs proximate to the center can have a high probability (e.g., larger than 0.9) as being a part of the same instance, which can correspond to a high confidence value. As the feature pairs become distant to the center the probability decreases (e.g., lower than 0.1), which can correspond to a low confidence value. The confidence value may be compared by the controller circuit 202 to a pre-determined non-zero threshold value. The pre-determined non-zero threshold value may correspond to a value that indicates a likelihood the probabilities correspond to the center.

At 414, the controller circuit 202 may be configured to identify a number of instances of the input image based on the clustering. For example, the number of instances may correspond to a number of centers identified during the clustering operation at 412. The controller circuit 202 may identify the number of centers, which corresponds to the number of instances.

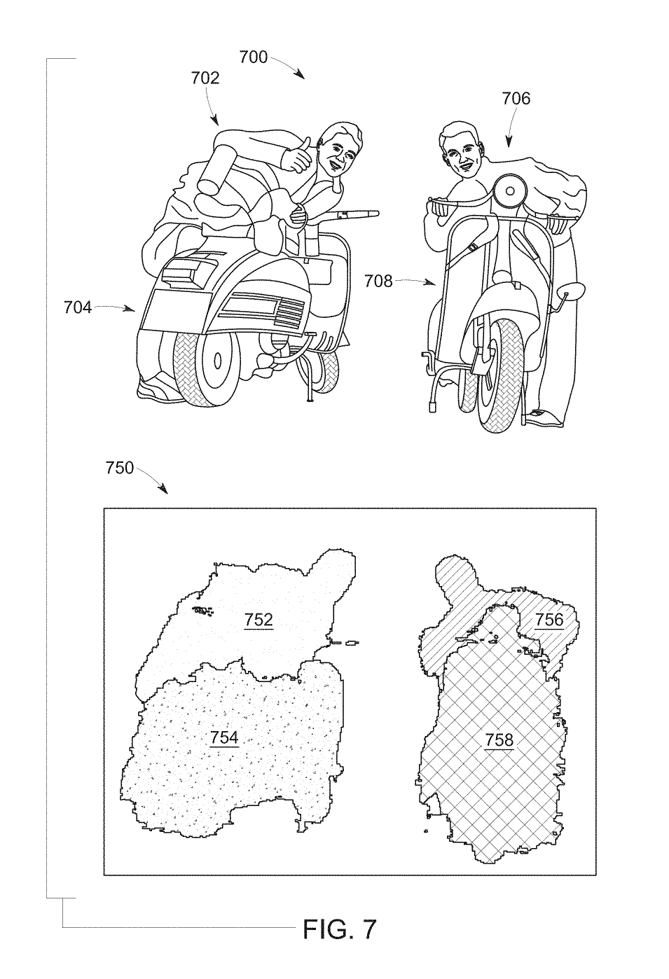

Optionally, the controller circuit 202 may be configured to segment the instances from the input image 502 (e.g., generate segments 514 shown in FIG. 5). FIG. 7 illustrates an embodiment of an input image 700 and an output image 750 with identified segments 752-758 corresponding to instances 702, 704, 706, 708 based on the artificial neural network 500. For example, the input image 700 is received at the artificial neural network 500 (FIG. 5), and includes a plurality of instances 702, 704, 706, 708. Based on the clustering, the controller circuit 202 may be configured to identify the instances 702, 704, 706, 708. For example, the controller circuit 202 may identify feature pairs of the input image 700 that belong to common instances (e.g., the instances 752-758) of the input image 700. Based on the feature pairs, the controller circuit 202 may generate an affinity graph indicating positions of the instances 702, 704, 706, 708 within the input image 700, and identify classes of the instances 702, 704, 706, 708 based on the C-Net layer 504. The controller circuit 202 may generate probability maps of the classes, which may be utilized with the affinity graph to cluster the feature pairs. Based on the clusters, the controller circuit 202 may segment the instances 702, 704, 706, 708 at the generate segments 514, which are shown as different colors in the output image 750 as the segments 752-758.

At 416, the controller circuit 202 may be configured to determine whether a select instance has been identified. For example, the controller circuit 202 may compare the classes identified by the C-Net layer 504 corresponds to a select instance stored in the memory 206. The select instance may be a tear, a crack, a face, and/or the like. The select instance may be a user defined instance based on input received from the user interface 208. Optionally, the select instance may be received by the controller circuit 202 via the bi-directional communication link. When the controller circuit 202 matches one of the identified classes with the select instance, the controller circuit 202 can determine that the select instance has been identified.

If the select instance has been identified, at 418, the controller circuit 202 may be configured to automatically take one or more remedial actions. For example, the select instance may represent damage, such as a tear and/or crack. The controller circuit 202 may be configured to automatically transmit an alert along the bi-directional communication link, display an alert on the display 210, and/or the like. Additionally or alternatively, the controller circuit 202 may display a location of the select instance within the input image 502. For example, based on the segmentation of the output image (e.g., the output image 750), the controller circuit 202 may include a location of the select instance in the input and/or output image. Optionally, the controller circuit 202 may transmit and/or display the output image having the segmentation with the select instance along the bi-directional communication link and/or the display 210.

In an embodiment a method (e.g., of instance semantic segmentation at the artificial neural network) is provided. The method includes examining an input image having a plurality of instances using an artificial neural network, and generating an affinity graph based on the input image. The affinity graph is configured to indicate positions of the instances within the input image. The method includes identifying a number of instances of the input image by clustering the instances based on the affinity graph.

Optionally, the method includes determining a feature map of the input image. The feature map includes feature vectors based on characteristics of pixels within the input image. The method includes selecting feature pairs of the feature map to identify feature pairs that have a common instance. The feature pairs being used to generate the affinity graph.

Optionally, the method includes categorizing classes of pixels in the input image, such that the classes of pixels are being used to form the affinity graph.

Optionally, the method includes determining a probability map. The probability map indicates a probability a feature pair of a feature map are a part of a common instance. Additionally or alternatively, the probability map is determined by iteratively determining probabilities of instances based on classes of the instances. Additionally or alternatively, the method includes determining a probability surface based on the probability map. The probability surface is used for the clustering. Additionally or alternatively, the clustering includes determining a center of the instances based on the probability surface.

Optionally, the method includes generating an output image indicating a location of the instances based on the clustering. Additionally or alternatively, the method includes identifying a select class of the instances, and transmitting the output image to a remote server when the select class is identified in the output image. Additionally or alternatively, the select class is a crack or a tear.

In an embodiment a system (e.g., an artificial neural network system) is provided. The system includes a memory configured to store an artificial neural network and a controller circuit. The controller circuit is configured to examine an input image having a plurality of instances at the artificial neural network, and generate an affinity graph based on the input image. The affinity graph is configured to indicate positions of the instances within the input image. The controller circuit is configured to identify a number of instances of the input image by clustering the instances based on the affinity graph.

Optionally, the controller circuit is configured to determine a feature map of the input image. The feature map includes feature vectors based on characteristics of pixels within the input image. The controller circuit is configured to select feature pairs of the feature map to identify feature pairs that have a common instance. The feature pairs are used by the controller circuit to generate the affinity graph.

Optionally, the controller circuit is configured to categorize classes of pixels in the input image, such that the classes of pixels are being used to form the affinity graph.

Optionally, the controller circuit is configured to determine a probability map. The probability map indicates a probability a feature pair of a feature map are a part of a common instance. Additionally or alternatively, the controller circuit is configured to determine the probability map by iteratively determining probabilities of instances based on classes of the instances. Additionally or alternatively, the controller circuit is configured to determine a probability surface based on the probability map. The probability surface being used for the clustering. Additionally or alternatively, the controller circuit is configured to cluster the instances by determining a center of the instances based on the probability surface.

Optionally, the controller circuit is configured to generate an output image indicating a location of the instances based on the clustering. Additionally or alternatively, the controller circuit is configured to identify a select class of the instances and transmit the output image to a remote server when the select class is identified in the output image. The select class being a crack or a tear.

In an embodiment a method (e.g., of instance semantic segmentation at the artificial neural network) is provided. The method includes examining an input image having a plurality of instances using an artificial neural network, determine a feature map of the input image. The feature map includes feature vectors based on characteristics of pixels within the input image. The method includes selecting feature pairs of the feature map to identify feature pairs that have a common instance, and identifying classes of pixels in the input image. The classes categorize the instances of the input image. The method includes determining a probability map. The probability map indicating a probability a feature pair of a feature map are a part of a common instance. The method includes generating an affinity graph based on the input image and the feature map. The affinity graph is configured to indicate positions of the instances within the input image. The method includes identifying a number of instances of the input image by clustering the instances based on the affinity graph. The classes are utilized during the clustering of the instances.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
examining an input image having a plurality of instances using an artificial neural network;
generating an affinity graph based on the input image, wherein the affinity graph is configured to indicate positions of the instances within the input image; and
identifying a number of instances of the input image by clustering the instances based on the affinity graph.

2. The method of claim 1, further comprising determining a feature map of the input image, wherein the feature map includes feature vectors based on characteristics of pixels within the input image; and
selecting feature pairs of the feature map to identify feature pairs that have a common instance, wherein the feature pairs being used to generate the affinity graph.

3. The method of claim 1, further comprising categorizing classes of pixels in the input image, wherein the classes of pixels is used to form the affinity graph.

4. The method of claim 1, further comprising determining a probability map, wherein the probability map indicates a probability a feature pair of a feature map are a part of a common instance.

5. The method of claim 4, wherein the probability map is determined by iteratively determining probabilities of instances based on classes of the instances.

6. The method of claim 4, further comprising determining a probability surface based on the probability map, wherein the probability surface is used for the clustering.

7. The method of claim 6, wherein the clustering includes determining a center of the instances based on the probability surface.

8. The method of claim 1, further comprising generating an output image indicating a location of the instances based on the clustering.

9. The method of claim 8, further comprising identifying a select class of the instances, and transmitting the output image to a remote server when the select class is identified in the output image.

10. The method of claim 9, wherein the select class is a crack or a tear.

11. A system comprising:
a memory configured to store an artificial neural network;
a controller circuit configured to:
examine an input image having a plurality of instances at the artificial neural network;
generate an affinity graph based on the input image, wherein the affinity graph is configured to indicate positions of the instances within the input image; and
identify a number of instances of the input image by clustering the instances based on the affinity graph.

12. The system of claim 11, wherein the controller circuit is configured to determine a feature map of the input image, wherein the feature map includes feature vectors based on characteristics of pixels within the input image, and select feature pairs of the feature map to identify feature pairs that have a common instance, wherein the feature pairs are used by the controller circuit to generate the affinity graph.

13. The system of claim 11, wherein the controller circuit is configured to categorize classes of pixels in the input image, the classes of pixels being used to form the affinity graph.

14. The system of claim 11, wherein the controller circuit is configured to determine a probability map, wherein the probability map indicates a probability a feature pair of a feature map are a part of a common instance.

15. The system of claim 14, wherein the controller circuit is configured to determine the probability map by iteratively determining probabilities of instances based on classes of the instances.

16. The system of claim 14, wherein the controller circuit is configured to determine a probability surface based on the probability map, wherein the probability surface is used for the clustering.

17. The system of claim 16, wherein the controller circuit is configured to cluster the instances by determining a center of the instances based on the probability surface.

18. The system of claim 11, wherein the controller circuit is configured to generate an output image indicating a location of the instances based on the clustering.

19. The system of claim 18, wherein the controller circuit is configured to identify a select class of the instances and transmit the output image to a remote server when the select class is identified in the output image, wherein the select class is a crack or a tear.

20. A method comprising:
examining an input image having a plurality of instances using an artificial neural network;
determine a feature map of the input image, wherein the feature map includes feature vectors based on characteristics of pixels within the input image;
selecting feature pairs of the feature map to identify feature pairs that have a common instance;
categorizing classes of pixels in the input image;
determining a probability map, wherein the probability map indicates a probability a feature pair of a feature map are a part of a common instance;
generating an affinity graph based on the input image and the feature map, wherein the affinity graph is configured to indicate positions of the instances within the input image; and
identifying a number of instances of the input image by clustering the instances based on the affinity graph, wherein the classes are utilized during the clustering of the instances.
